(19) United States
(12) Patent Application Publication
(10) Pub. No.: US 2011/0107228 A1
(43) Pub. Date: May 5, 2011

(54) METHOD OF SIMULTANEOUSLY DISPLAYING STATUS OF A PLURALITY OF CONTACTS IN AN ADDRESS BOOK AND RELATED COMMUNICATION DEVICE

(76) Inventor: Chun-Min Huang, Taipei City (TW)

(21) Appl. No.: 12/829,389

(22) Filed: Jul. 2, 2010

(30) Foreign Application Priority Data
Oct. 29, 2009 (TW) 098136637

(51) Int. Cl. G06F 3/048

(52) U.S. Cl. 715/739

(57) ABSTRACT

A method of simultaneously displaying status of a plurality of contacts in an address book of a communication device includes accessing the address book, editing a plurality of accounts of a plurality of internet communication software of the contacts in the address book interface, connecting to the network, acquiring an online status of the accounts, and displaying images representing the contacts in the address book and displaying a plurality of status icons corresponding to the accounts of the plurality of internet communication software of the contacts so as to display the online status of the accounts of the contacts.

### BACKGROUND OF THE INVENTION

1. Field of the Invention

The present invention relates to a method of displaying a status of contacts in an address book and a related communication device, and more particularly, to a method of simultaneously displaying status of contacts in an address book and a related communication device.

2. Description of the Prior Art

Due to easy, convenient, and plentiful operational functions, internet communication software is the favorite communication technique in modern years. Many internet communication services provide the exclusive internet communication software to be downloaded and be used in free. The internet communication software includes a plurality of instant messenger software, such as Skype, MSN messenger, Yahoo messenger, Google Talk, AIM, and so on, and various email mailboxes, such as Gmail, Yahoo mail, MSN mail, and so on. Consumers at different ages and in different regions utilize different internet communication software because of their different operational customs. Most people have accounts in a plurality of instant messenger software and in a plurality of email mailboxes, respectively. When a user communicates with friends via the internet communication software, the user often starts the plurality of instant messenger software so as to search accounts of the friends, or the user often starts several email mailboxes so as to check whether the mailboxes store unread mails. Therefore, the user has to start the plurality of instant messenger software and several email mailboxes simultaneously, resulting in inconvenience of the operation and wasting time, and a loading of the computer system is increased when the plurality of internet communication software is operated simultaneously. The user may miss connection with a friend when the user forgets to login the specific internet communication software which the friend uses.

### SUMMARY OF THE INVENTION

The present invention provides a method of simultaneously displaying status of contacts in an address book and a related communication device for solving above drawbacks.

According to the claimed invention, a method of simultaneously displaying status of a plurality of contacts in an address book of a communication device includes accessing the address book, editing a plurality of accounts of a plurality of internet communication software of the contacts in the address book, connecting to the network; acquiring an online status of the accounts, and displaying images representing the contacts in the address book and displaying a plurality of status icons corresponding to the accounts of the plurality of internet communication software on the images based on the online status so as to display the online status of the plurality of accounts of the contacts.

According to the claimed invention, a communication device includes a memory module for storing a plurality of internet communication software and for storing a program of an address book, the address book comprising images representing a contact and a plurality of status icons corresponding to accounts of the plurality of internet communication software of the contacts so as to display an online status of the accounts of the contacts, an internet communication module for connecting to a plurality of servers of the plurality of internet communication software, a display module for displaying the address book, an inputting module for inputting an editing command so as to edit the address book, and a control unit for controlling the internet communication software to connect to the plurality of servers of the plurality of internet communication software and for controlling the display module to simultaneously display the images corresponding to the contact and the plurality of status icons in the address book.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a communication device for simultaneously displaying status of a plurality of internet communication software of contacts in an address book according to a preferred embodiment of the present invention.

FIG. 2 is a frame diagram of a sign-in page according to the preferred embodiment of the present invention.

FIG. 3 is a frame diagram of the address book according to the preferred embodiment of the present invention.

FIG. 4 is a flow chart of a method of simultaneously displaying the status of the plurality of internet communication software of the contacts in the address book according to the preferred embodiment of the present invention.

### DETAILED DESCRIPTION

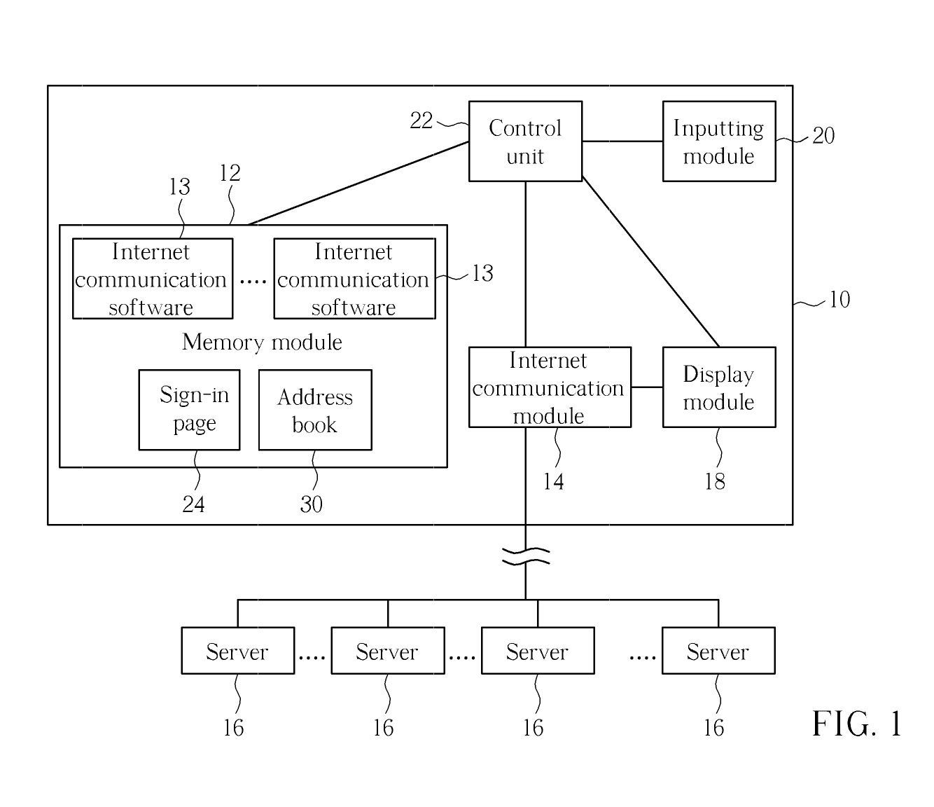

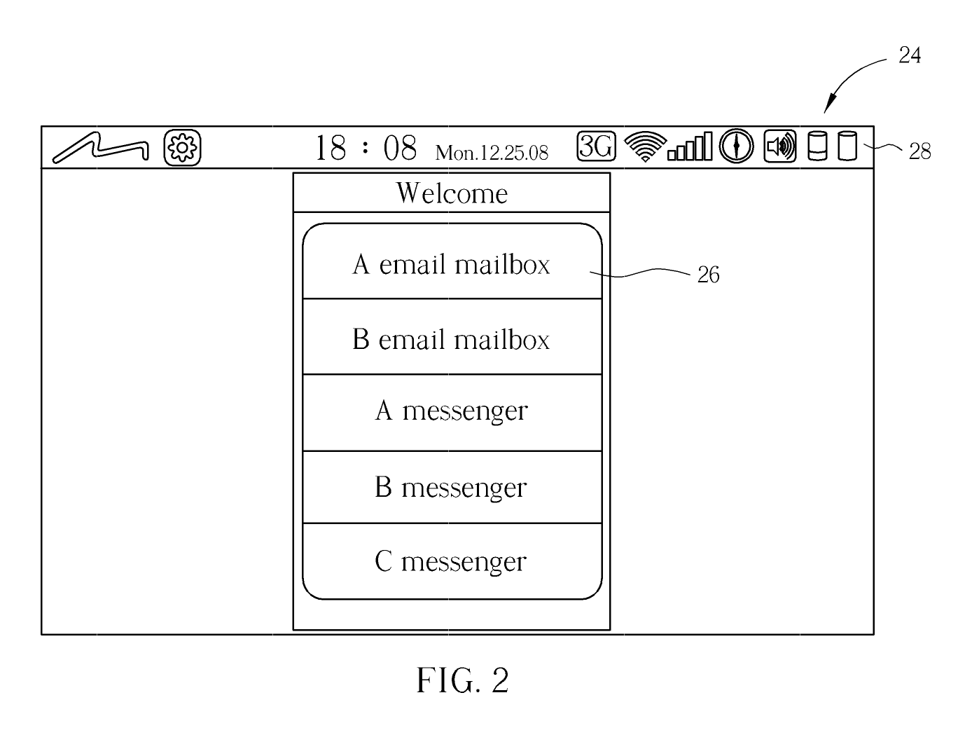

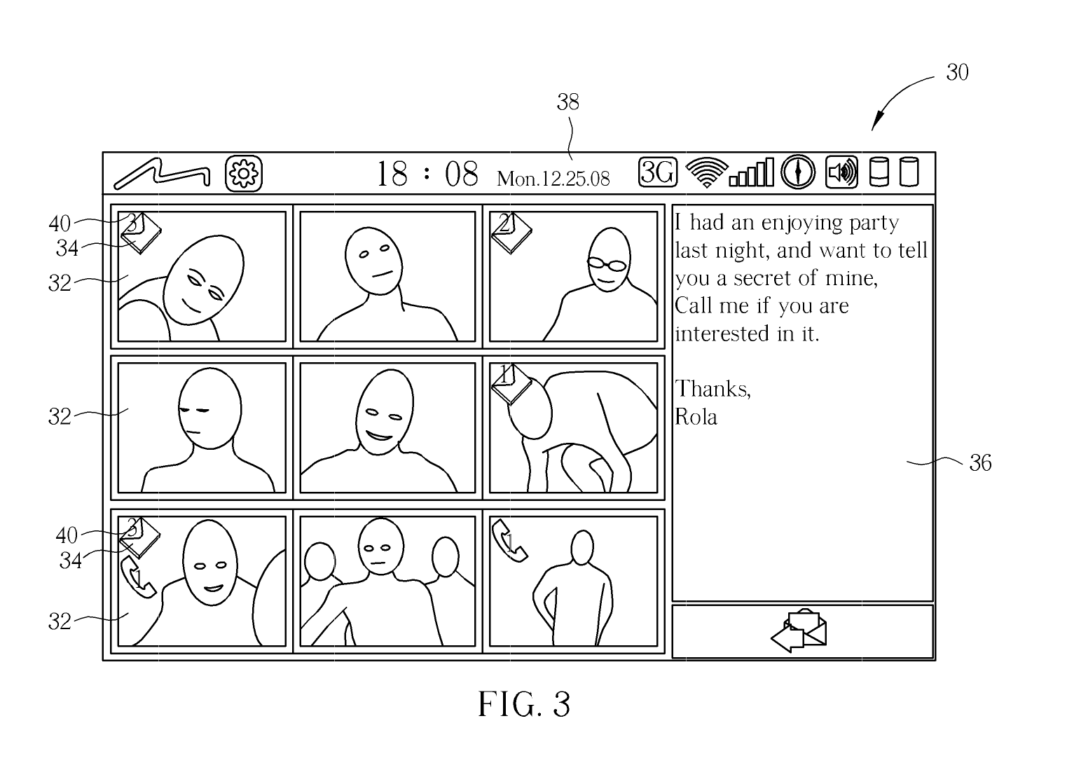

Please refer to FIG. 1 to FIG. 3. FIG. 1 is a functional block diagram of a communication device 10 for simultaneously displaying status of a plurality of internet communication software of contacts in an address book according to a preferred embodiment of the present invention. FIG. 2 is a frame diagram of a sign-in page 24 according to the preferred embodiment of the present invention. FIG. 3 is a frame diagram of an address book 30 according to the preferred embodiment of the present invention. The communication device 10 can be a computer system with an internet communication function or a portable electronic device with the internet communication function, such as a desktop computer, a notebook computer, a mobile phone, a personal digital assistant, and so on. The communication device 10 includes a memory module 12 for storing a plurality of internet communication software 13, a program of the sign-in page 24, and a program of the address book 30. The communication device 10 further includes an internet communication module 14 for connecting to a plurality of servers 16 of the plurality of internet communication software 13 on the internet, a display module 18 for displaying the sign-in page 24 and the address book 30, an inputting module 20 for inputting an edit command so as to edit the sign-in page 24 and the address book 30, and a control unit 22 for controlling the internet communication module 14 to connect to the plurality of servers 16 of the plurality of internet communication software 13 on the internet and for controlling the display module 18 to display the sign-in page 24 and the address book 30.

The inputting module 20 can be utilized to input accounts and a plurality of passwords of the plurality of internet communication software 13 in the sign-in page 24, and then the control unit 22 can control the internet communication module 14 to login the plurality of servers 16 of the plurality of internet communication software 13 on the internet respectively according to the accounts and the plurality of passwords of the plurality of internet communication software 13 before accessing the address book 30. The sign-in page 24 can store and install the selected internet communication software 13 and the account and the password of the selected internet communication software 13. The internet communication software 13 can be instant messenger software, such as Skype, MSN Messenger, Yahoo Messenger, Google Talk, AIM, ICQ, and so on. The internet communication software 13 can further be email mailbox software, such as Gmail, Yahoo mail, MSN mail, and so on.

As shown in FIG. 2, the sign-in page 24 includes a selecting window 26 for selecting the internet communication software 13 and for inputting the account and the password of the corresponding internet communication software 13, so as to automatically login the plurality of internet communication software 13 selectively. The sign-in page 24 can further include a tool bar 28 for displaying external information, such as time information, data information, volume information, and so on.

As shown in FIG. 3, the address book 30 includes at least one image 32 representing at least one contact, and the image 32 includes a plurality of status icons corresponding to the accounts of the plurality of internet communication software 13 of the contacts so as to display an online status of the plurality of accounts of the contacts. Besides the image 32 and the status icons 34, the address book 30 can further include an inputting window 36 for transmitting a datum to the corresponding accounts of the contacts when one of the status icons 34 is selected, such as transmitting a text message or a film to the corresponding accounts of the contacts via the inputting window 36. The address book 30 can further include a tool bar 38 for displaying information, such as time information, date information, volume information, and so on. The address book 30 can further include at least one numeral 40 for representing a number of unread messages of the accounts of the corresponding internet communication software 13 of the contacts. For example, the numeral 40 can be overlapped with the status icon 34 for representing the number of the unread messages of the corresponding accounts of the internet communication software 13 of the contacts.

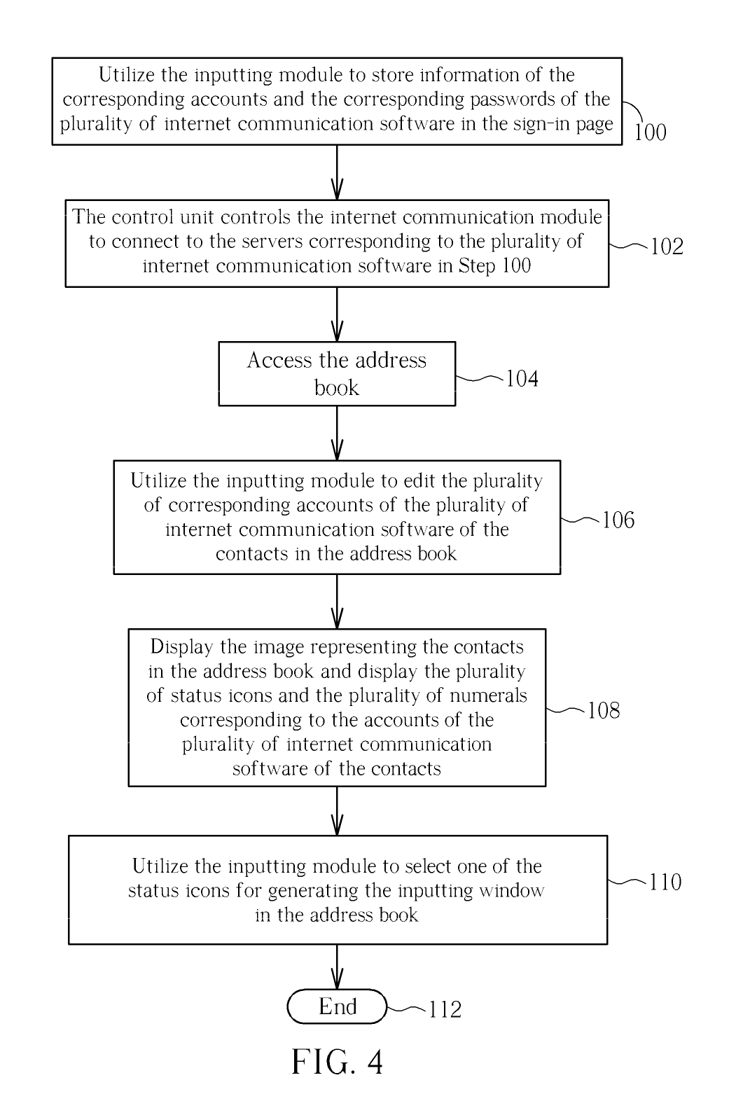

Please refer to FIG. 4. FIG. 4 is a flow chart of a method of simultaneously displaying the status of the plurality of internet communication software 13 of the contacts in the address book according to the preferred embodiment of the present invention. The method includes following steps:

Step 100: Utilize the inputting module 20 to store information of the corresponding accounts and the corresponding passwords of the plurality of internet communication software 13 in the sign-in page 24;

Step 102: The control unit 22 controls the internet communication module 14 to connect to the servers 16 corresponding to the plurality of internet communication software 13 in Step 100;

Step 104: Access the address book 30;

Step 106: Utilize the inputting module 20 to edit the plurality of corresponding accounts of the plurality of internet communication software 13 of the contacts in the address book 30. For example, selecting the images 32 representing the contacts and recording the accounts of the plurality of internet communication software 13 of the contacts and a comment thereof in the address book 30;

Step 108: Display the images 32 representing the contacts in the address book 30 and display the plurality of status icons 34 and the plurality of numerals 40 corresponding to the accounts of the plurality of internet communication software 13 of the contacts so as to display the online status of the accounts of the contacts;

Step 110: Utilize the inputting module 20 to select one of the status icons 34 for generating the inputting window 36 in the address book 30 so as to utilize the inputting window 36 to transmit the datum to the corresponding accounts of the contacts;

Step 112: End.

Detailed description of the method is introduced as follows. First, a user can utilize the inputting module 20 to input accounts and passwords of the plurality of selected internet communication software 13 in the sign-in page 24, so that the control unit 22 controls the internet communication module 14 to login the servers 16 of the plurality of internet communication software 13 before accessing the address book 30. For example, the user can utilize the inputting module 20 to input the accounts and the passwords of the plurality of selected internet communication software 13 in the sign-in page 24 before accessing the address book 30 every time. The user can further selectively store and install the internet communication software 13, and the account and the password of the set internet communication software 13, so that the control unit 22 controls the internet communication software 13 to login the sever 16 of the predetermined internet communication software 13 automatically before accessing the address book 30. Then, the control unit 22 executes the program of the address book 30 and controls the display module 18 to display the address book 30. Therefore, the user can utilize the inputting module 20 to edit the accounts of the plurality of internet communication software 13 of the contacts. For example, the user can utilize the inputting module 20 to select the images 32 representing the contacts and to record the accounts of the plurality of internet communication software 13 of the contacts and a comment thereof.

The address book 30 can simultaneously display the status of the corresponding accounts of the plurality of internet communication software 13 of the contacts via the status icons 34, the numerals 40, and color variations, status variations (displaying/hiding), and modeling variations of the images 32. For example, color of the image 32 is varied so as to represent the online status of the contact. The image 32 becomes a color image so as to represent an online status of the contact, or the image 32 becomes a gray image so as to represent an offline status of the contact. The color of the image 32 is not varied with the online status of the corresponding email accounts of the contacts. In addition, when the corresponding account of the contact is in the online status actually, the contact can utilize a function of the internet communication software 13 to set the corresponding account in the offline status. For this reason, the present invention can design the available communication of the user and the corresponding accounts of the contacts when showing the corresponding accounts of the contacts in the online or offline status. That is to say, when the image 32 of the contact shows the offline status, the user still can send an offline message or an email to the corresponding accounts of the contacts. Method of the image 32 representing the online status and offline status of the contact is not limited to the above-mentioned embodiment and depend on actual demand. For example, the image 32 can twinkle or rotate to represent the online status.

Because the contact often has the accounts on the plurality of internet communication software 13, the images 32 representing the contact can display the plurality of status icons 34 corresponding to the accounts of the plurality of internet communication software 13 of the contacts. For example, if the contact has an account on Skype, the image 32 can display a microphone-shaped status icon 34. If the contact has an account on MSN messenger, the image 32 can display a humanoid-shaped status icon 34. If the contact has an account on Yahoo mail, the image 32 can display an envelope-shaped status icon 34 with a Y mark. Method of showing the status icons 34 corresponding to the internet communication software 13 is not limited to the above-mentioned embodiments. For example, the user can design the status icons or download the status icons from internet, and depend on actual demand.

Furthermore, the status icons 34 can represent the online status, a message status, an incoming call status, or a mail status of the accounts of the corresponding internet communication software 13 of the contacts. Color of the status icon 34 can be varied so as to represent an online status or an offline status of the accounts of the corresponding internet communication software 13 of the contacts. For example, the status icon 34 becomes a color image so as to represent the online status of the account of the corresponding internet communication software 13 of the contact, or the status icon 34 becomes a gray image so as to represent the offline status of the account of the corresponding internet communication software 13 of the contact. The status icon 34 can include a plurality of color images so as to represent a plurality of online statuses of the accounts of the corresponding internet communication software 13 of the contacts. For example, the status icon 34 can become an orange image for representing an away status of the account of the corresponding internet communication software 13 of the contact, the status icon 34 can further become a red image for representing a busy status of the account of the corresponding internet communication software 13 of the contact, and the status icon 34 can further become a green image for representing an available status of the account of the corresponding internet communication software 13 of the contact. The internet communication software 13 further can display the status icon 34 for representing the online status of the account of the corresponding internet communication software 13 of the contact, or can hide the status icon 34 for representing the offline status of the account of the corresponding internet communication software 13 of the contact. Methods of the status icon 34 representing the online status or the offline status of the accounts of the corresponding internet communication software 13 of the contacts are not limited to the above-mentioned embodiment and depend on actual demand. For example, the status icon 34 can twinkle or rotate to represent the online status.

In addition, the status icons 34 can display the numeral 40 for representing the number of the unread messages of the accounts of the corresponding internet communication software 13 of the contacts, and can hide the numeral 40 for representing all messages having been read of the account of the corresponding internet communication software 13 of the contacts. The numeral 40 can twinkle for representing an instant unread message of the accounts of the corresponding internet communication software 13 of the contacts. Method of the numeral 40 representing the message status of the accounts of the corresponding internet communication software 13 of the contacts is not limited to the above-mentioned embodiment and depends on actual demand.

Furthermore, the user can utilize the inputting module 20 to select the status icon 34 to generate the inputting window 36 selectively, so as to transmit the datum to the corresponding accounts of the contacts, such as a text message, a film, a video, and so on. Therefore, the operational complication is decreased and operational hours are economized, effectively.

Comparing to the prior art, the method of displaying the status of the contacts in the address book and a related communication device of the present invention can display the status of the plurality of internet communication software of the contacts in the address book on an operation interface simultaneously, integrate the accounts of the plurality of internet communication software of the contacts into an image effectively, and utilize the status icons and numerals to represent the different statuses of the corresponding accounts of the plurality of internet communication software of the contacts. The user can login the plurality of servers of the plurality of internet communication software via only single address book. The address book can simultaneously display the status of the accounts of the plurality of internet communication software of the contacts. The user can further utilize the inputting window on the address book to transmit the datum to the accounts of plurality of internet communication software of the corresponding contacts, so that the present invention can effectively integrate functions of different internet communication software for promoting operational convenience.

Those skilled in the art will readily observe that numerous modifications and alterations of the device and method may be made while retaining the teachings of the invention.

What is claimed is:

1. A method of simultaneously displaying status of a plurality of contacts in an address book of a communication device comprising:
accessing an address book;
editing a plurality of accounts of a plurality of internet communication software of the contacts in the address book;
connecting to the network;
acquiring an online status of the accounts; and
displaying images representing the contacts in the address book and displaying a plurality of status icons corresponding to the accounts of the plurality of internet communication software on the images based on the online status so as to display the online status of the plurality of accounts of the contacts.

2. The method of claim 1 further comprising:
storing information of the plurality of accounts and a plurality of passwords of a user of the communication device corresponding to the plurality of internet communication software in a sign-in page so as to respectively connect to a plurality of servers of the plurality of internet communication software.

3. The method of claim 2 further comprising:
storing and installing the selected internet communication software and the account and the password of the user of the selected internet communication software so as to automatically sign in the selected internet communication software.

4. The method of claim 1, wherein editing the plurality of accounts of the plurality of internet communication software of the contacts in the address book comprises selecting the image representing the contact and recording the plurality of accounts of the plurality of internet communication software of the contacts a comment thereof in the address book.

5. The method of claim 1, wherein each status icon represents an online status, a message status, an incoming call status, or a mail status of the accounts of the corresponding internet communication software of the contacts.

6. The method of claim 1 further comprising:
selecting one of the status icons to generate an inputting window in the address book so as to utilize the inputting window to transmit a datum to the corresponding account of the contacts.

7. The method of claim 1, wherein colors of the image is varied so as to represent an online status and an offline status of the contact.

8. The method of claim 7, wherein the image becomes a color image so as to represent the online status of the contact, or the image becomes a gray image so as to represent the offline status of the contact.

9. The method of claim 1, wherein color of each status icon is varied so as to represent an online status and an offline status of the accounts of the corresponding internet communication software of the contacts.

10. The method of claim 9, wherein the status icon becomes a color image so as to represent the online status of the accounts of the corresponding internet communication software of the contacts, or the status icon becomes a gray image so as to represent the offline status of the accounts of the corresponding internet communication software of the contacts.

11. The method of claim 10, wherein each status icon comprises a plurality of color image so as to represent a plurality of online statuses of the accounts of the corresponding internet communication software of the contacts.

12. The method of claim 1 further comprising:
displaying one of the status icons to represent an online status of the accounts of the corresponding internet communication software of the contacts or hiding the status icon to represent an offline status of the accounts of the internet communication software of the contacts.

13. The method of claim 1, wherein the status icon comprises a numeral for representing a number of unread messages of the accounts of the corresponding internet communication software of the contacts.

14. The method of claim 13, wherein the numeral twinkles for representing an instant unread message of the accounts of the corresponding internet communication software of the contacts.

15. The method of claim 1 further comprising:
displaying a tool bar comprising time information, date information, or volume information on the address book.

16. The method of claim 1, wherein the internet communication software is instant messenger (IM) software.

17. The method of claim 1, wherein the internet communication software is E-mail box software.

18. A communication device comprising:
a memory module for storing a plurality of internet communication software and for storing a program of an address book, the address book comprising images representing a contact and a plurality of status icons corresponding to accounts of the plurality of internet communication software of contacts so as to display an online status of the accounts of the contacts;
an internet communication module for connecting to a plurality of servers of the plurality of internet communication software;
a display module for displaying the address book;
an inputting module for inputting an editing command so as to edit the address book; and
a control unit for controlling the internet communication software to connect to the plurality of servers of the plurality of internet communication software and for controlling the display module to simultaneously display the images corresponding to the contacts and the plurality of status icons in the address book.

19. The communication device of claim 18, wherein each status icon represents the online status, a message status, an incoming call status, or a mail status of the accounts of the contacts.

20. The communication device of claim 18, wherein the control unit is for controlling the display device to display a numeral so as to represent a number of unread messages of the accounts of the corresponding internet communication software of the contacts.
